(19) United States
(12) Patent Application Publication
(10) Pub. No.: US 2005/0109862 A1
(43) Pub. Date: May 26, 2005

(54) Compressed air foam nozzle

(76) Inventor: Mark D. Baxter, Mountain Springs, NV (US)

Correspondence Address: Anderson & Morishita, L.L.C., Suite 102, 2725 S. Jones Blvd., Las Vegas, NV, 89146, US

(21) Appl. No.: 10/956,879

(22) Filed: Oct. 1, 2004

Related U.S. Application Data
(60) Provisional application No. 60/508,621, filed on Oct. 3, 2003.

(51) Int. Cl. F41B 11/00; B05B 1/26; B05B 1/34

(52) U.S. Cl. 239/461; 239/463; 239/483

(57) ABSTRACT

A nozzle for broadcasting compressed air foam includes a hollow barrel and a deflector positioned at least partially inside the hollow barrel. The hollow barrel includes an inlet and expands toward an outlet. Optionally, the hollow barrel is defined by a flat surface or a curvilinear surface. The deflector has a tapered body that, optionally, transitions to a convex curve. The shape of the tapered body may conform to the shape of the inner surface of the hollow barrel. The space between the deflector and the hollow barrel defines a passageway for the compressed air foam. The deflector may be fixed or free to rotate.

### RELATED APPLICATION DATA

The present application claims the priority of U.S. Provisional Application Ser. No. 60/508,621, entitled “Compressed Air Foam Sprinkler System,” filed Oct. 2, 2003 by Applicant herein.

### FIELD OF THE INVENTION

The present invention relates to nozzles for the delivery of compressed air foam. More specifically, the present invention is directed to a nozzle that includes a deflector to broadcast compressed air foam over a wide area.

### BACKGROUND OF THE INVENTION

Aqueous surfactant solutions were first used in fire fighting by pumping these solutions through air-aspirating nozzles. This type of nozzle uses significant turbulence within and immediately proximal to the nozzle in order to facilitate entrainment of air, thereby causing the formation of foam. Such air-aspirated foam is comprised of bubbles of varying sizes with varying degrees of surface tension which results in a fast draining foam that has a very “wet” consistency, that adhered to structures somewhat better than plain water, smothered fires somewhat better than plain water, yet flowed off of burning and non-burning fuel fairly quickly. Even so, air-aspirated foam was an improvement in fire fighting and, when used, resulted in extinguishing fires twice as fast and with half the water than similar fires that were fought with plain water.

Some time later it was discovered that if compressed air were injected into the stream of aqueous surfactant solution at or near the pump, rather than aspirated into the stream of foam at the nozzle, the resulting foam would consist of bubbles of uniform size, with essentially uniform surface tension, resulting in a slow draining foam with a “drier” consistency that adhered to structures much better, smothered fires much better and took much longer to flow off of burning and non-burning fuel. This resulted in a dramatic improvement in fire fighting and resulted in extinguishment of fires four times faster and with one-third the amount of water than similar fires fought with plain water. It was also found that compressed air foam can be used very effectively for pretreatment of structures to prevent their ignition from fire.

Prior to the use of compressed air foam, hose lines were generally equipped with nozzles that could be adjusted to provide any width of stream from very narrow to extremely wide. Such nozzles cannot be used with compressed air foam however because the considerable turbulence within the nozzle would break down the foam bubbles prematurely. Premature bubble breakdown results in an accelerated drain time and a “wetter” foam that does not adhere to structures or smother fire as effectively as a “drier” compressed air foam that has not been degraded by turbulence. Due to the vulnerability of compressed air foam to degradation by turbulence, deployment from hose lines and monitors has always been solely with straight bore tips which create very minimal turbulence. Although the resulting stream of foam can reach a considerable distance, it has a fairly narrow area of coverage unless the hose line or monitor is traversed back and forth.

Attempts to deploy compressed air foam from fixed pipe sprinkler systems have found that sprinklers designed to spray plain water, as well as those designed to spray an aqueous surfactant solution that produces aspirated foam, both result in considerable turbulence that significantly breaks down compressed air foam and degrades its performance. A fixed pipe sprinkler system equipped with straight bore tip sprinkler heads would have little use since such tips would provide a very limited area of coverage.

Some headway in this field of application has been made through research conducted by the National Research Council, Canada. The NRCC has deployed compressed air foam in fixed pipe sprinkler systems equipped with two types of foam sprinkler heads, as disclosed in U.S. Pat. No. 6,328,225 and Canadian Patent 2131109. Although the better of the two heads enables a system to extinguish fires twice as fast and with half the amount of water than if plain water were used, it is believed that the foam is being degraded by significant turbulence because this level of performance is commensurate with aspirated foam but still does not approach the effectiveness possible with compressed air foam. In fact, the turbulence within the sprinkler heads not only significantly degrades quality of the foam but also drains a considerable amount of mechanical energy from the foam thereby significantly decreasing the foam's ejection velocity. When deployed from ceilings, for example, this decreased ejection velocity significantly compromises the ability of the foam to penetrate the fire plume and reach the base of the fire where the foam would be most effective. As would be expected, this drastically reduces the ability of the foam to extinguish the fire.

Thus, it can be seen that there is a need in the art for a nozzle that broadcasts compressed air foam evenly over a wide area with a sufficient velocity, while reducing turbulence within the nozzle, thereby avoiding breakdown of the foam.

### SUMMARY OF THE INVENTION

The present invention is directed to a nozzle for broadcasting compressed air foam. The nozzle includes a hollow barrel with an inlet and an outlet, in which the hollow barrel has a shape expanding from the inlet to the outlet. Optionally, the inside surface of the hollow barrel is frustoconical. In such an embodiment, the surface of the frustoconical inner surface may take many forms including a flat surface, or a curvilinear surface defined by a hyperbolic curve, logarithmic curve, elliptical arc, circular arc, or the like.

A deflector is disposed inside the hollow barrel proximate the outlet with the space between the hollow barrel and the deflector defining a passageway for the compressed air foam. The deflector includes a tapered body that expands toward the outlet. In an optional embodiment, the tapered body of the deflector is shaped substantially like the inside surface of the hollow barrel. Optionally, the tapered body transitions to a convexly curved surface. In such an optional embodiment, the convexly curved surface is shaped to direct compressed air foam toward the longitudinal axis of the deflector, as a result, at least in part, of the Coanda effect. Alternatively, the deflector may be sized and shaped with respect to the outlet to define a passageway that broadcasts compressed air foam substantially laterally.

In a further optional embodiment, the deflector is rotatable about a longitudinal axis and terminates in an end. The deflector of such an optional embodiment may include at least one channel having an opening on the body communicating with an opening at said end. The channel may be angled with respect to the longitudinal axis such that compressed air foam passing through said channel causes the deflector to rotate.

In another optional embodiment, the passageway of the nozzle may define an arc of less than a complete circle to broadcast said compressed air foam in an arc of less than a complete circle.

In one optional embodiment, the deflector is at least partially retractable into the hollow barrel. In such an optional embodiment, a removable cap may also be engaged to the nozzle to retain the deflector. Optionally, the removable cap may be disengaged from the nozzle by the flow of compressed air foam.

In yet another embodiment, the position of the deflector with respect to the outlet may be adjustable. Optionally, the position is adjustable when the nozzle is in use, i.e. when compressed air foam is flowing through the nozzle.

### BRIEF DESCRIPTION OF THE DRAWINGS

FIG. 1 is a side view of a hollow barrel according to an embodiment of the present invention;

FIG. 2 is a side view of a deflector according to an embodiment of the present invention;

FIG. 3 is a cutaway side view of a compressed air foam nozzle according to an embodiment of the present invention;

FIG. 4 is a cutaway side view of a compressed air foam nozzle according to an embodiment of the present invention;

FIG. 5 is a bottom view of a deflector according to the embodiment of FIG. 4;

FIG. 6 is a cutaway side view of a compressed air foam nozzle according to an embodiment of the present invention;

FIG. 7 is a bottom view of a deflector according to the embodiment of FIG. 6;

FIG. 8 is a cutaway side view of a compressed air foam nozzle according to an embodiment of the present invention.

### DESCRIPTION

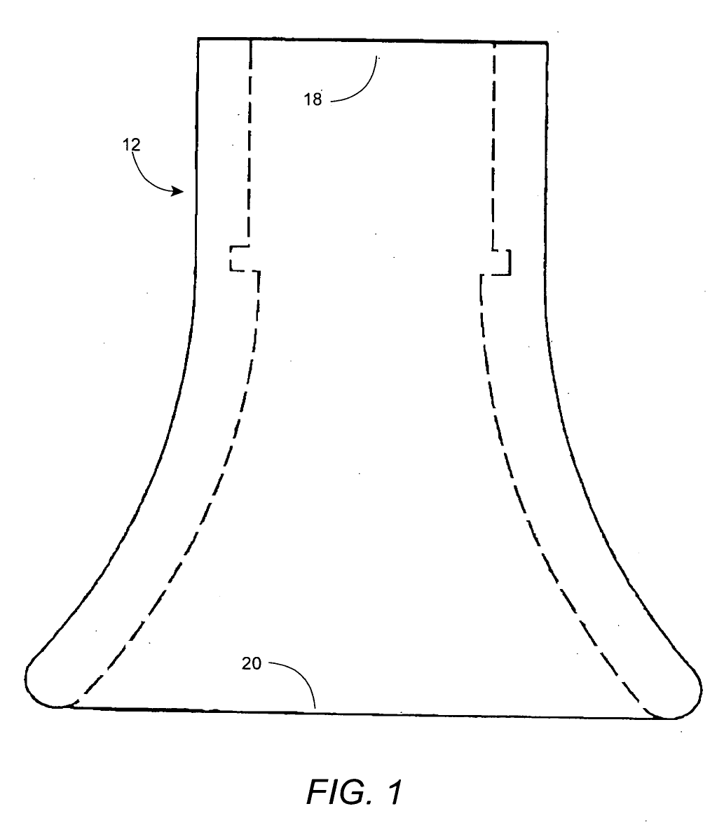

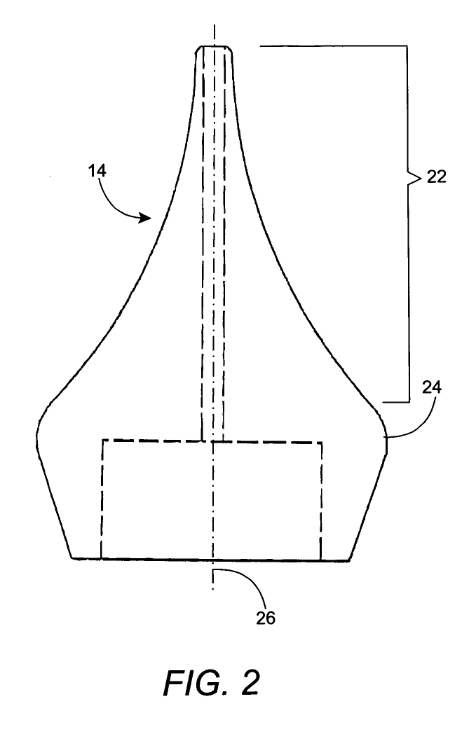

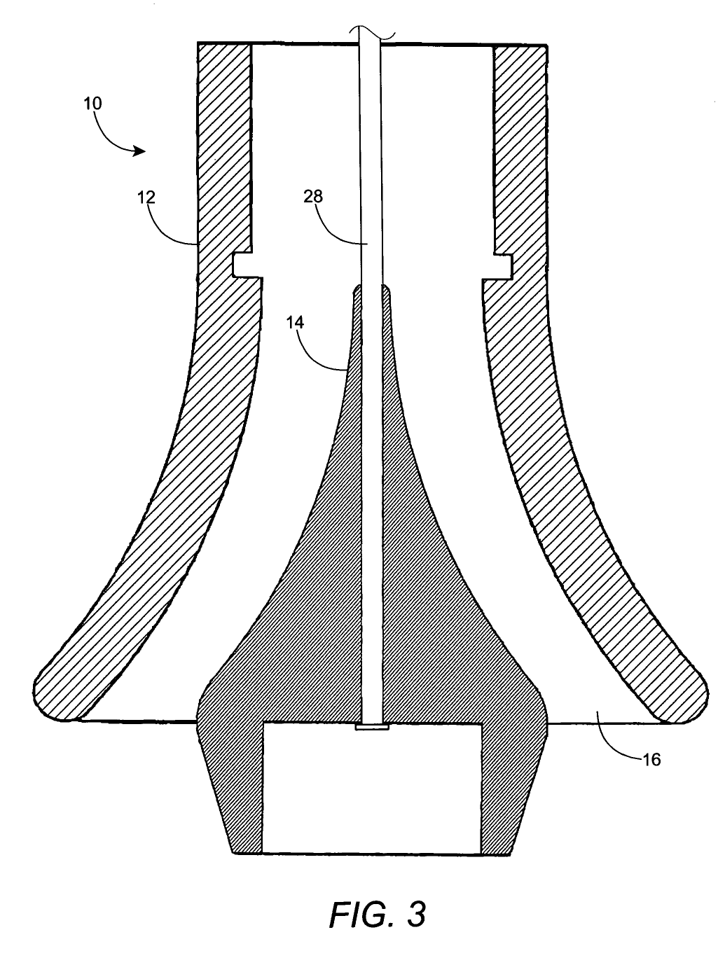

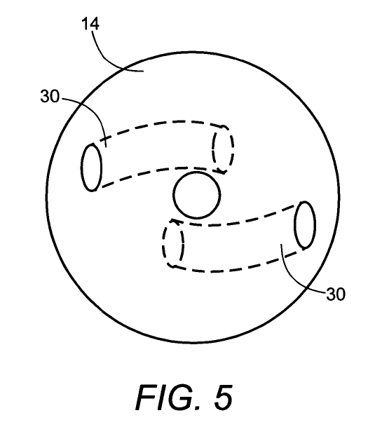

Reference is now made to the figures wherein like parts are referred to by like numerals throughout. As shown in FIGS. 1-8, the present invention is a nozzle 10 for the delivery of compressed air foam. It is contemplated that the nozzle 10 of the present invention could be attached to any device, including pipes, sprinkler pipes, hoses, monitors, or any other compressed air foam source, and could deliver compressed air foam for any purpose, including firefighting, biological or chemical decontamination, or any other purpose. To this end, the nozzle 10 of the present invention may be removable from or fixed to the compressed air foam source, and may be compatible with known automatic systems incorporating fuseable links or thermal fuses that trigger the broadcast of compressed air foam. Further, it is intended that the term “compressed air foam” not be limited to foams formed from compressed atmospheric air, but could be formed from the introduction of nitrogen, carbon dioxide, argon, or any other suitable gases.

As shown in FIGS. 1-8, the present invention is a nozzle 10 having a hollow barrel 12 through which compressed air foam for firefighting or for other purposes flows and a deflector 14 at least partially received into the hollow barrel. The space between the hollow barrel and the deflector defines a passageway 16 through which the compressed air foam flows, with the shape of the deflector 14 and hollow barrel 12 directing the broadcast of the compressed air foam.

The hollow barrel 12 includes an inlet 18 and an outlet 20. The inlet 18 may take many forms and communicates with a compressed air foam source. Compressed air foam delivered to the inlet 18 flows through the hollow barrel 12 toward the outlet 20. Optionally, the hollow barrel 12 expands from the inlet 18 toward the outlet 20. For example, the hollow barrel 12 may have a frustoconical shape with the smaller end at the inlet 18 and the larger end at the outlet 20. The frustoconical shape may be defined by a flat surface, i.e. where a straight line connects the larger end to the smaller end, or by a curvilinear surface, i.e. where a curved line connects the larger end to the smaller end. Additionally, it is contemplated that the curvilinear surface may be defined by any form of curve, including a hyperbolic curve, a logarithmic curve, an elliptical arc, a circular arc, or any other curve.

The deflector 14 includes a tapered body 22. As with the hollow barrel, the tapered body 22 may take any shape including conical, frustoconical, pyramidal, or any other shape. In an optional embodiment, the shape of the tapered body 22 of the deflector 14 conforms to the shape of the inner surface of the barrel 12. In such an optional embodiment, the deflector 14 and barrel 12 are substantially parallel to define a fairly consistent passageway 16 so that compressed air foam may flow between, and be directed by, the two surfaces.

In one optional embodiment, the tapered body 22 of the deflector 14 transitions to a convex curve 24. That is, as the tapered body 22 expands near the outlet 20, the surface of the deflector 14 is smoothly curved in the opposite direction, i.e. a convex curve 24, such that some of the foam follows the surface of the deflector 14, as a result of the Coanda effect, to fill any void near the longitudinal axis 26 of the deflector 14 that would otherwise be created by the deflector 14 itself. This aids in avoiding the uneven coverage of foam that might be caused by a void in the compressed air foam stream.

The deflector 14 may be positioned in the hollow barrel in a variety of ways. In one optional embodiment, the deflector is positioned using flexible or non-flexible wires, cables, rods or other attachment mechanism 28. The attachment mechanism 28 positions and holds the deflector 14 at least partially in the hollow barrel 12. The attachment mechanism 28 may be attached to the deflector 14 in such a way as to allow the deflector 14 to freely rotate. In such an optional embodiment, the wire, cable, rod, or other attachment mechanism 28 between the deflector 14 and the hollow barrel 12 may be connected through a bearing (not shown) that permits rotation of the deflector 14. In another optional embodiment, the deflector 14 may instead be attached in such a way as to prevent the deflector 14 from rotating.

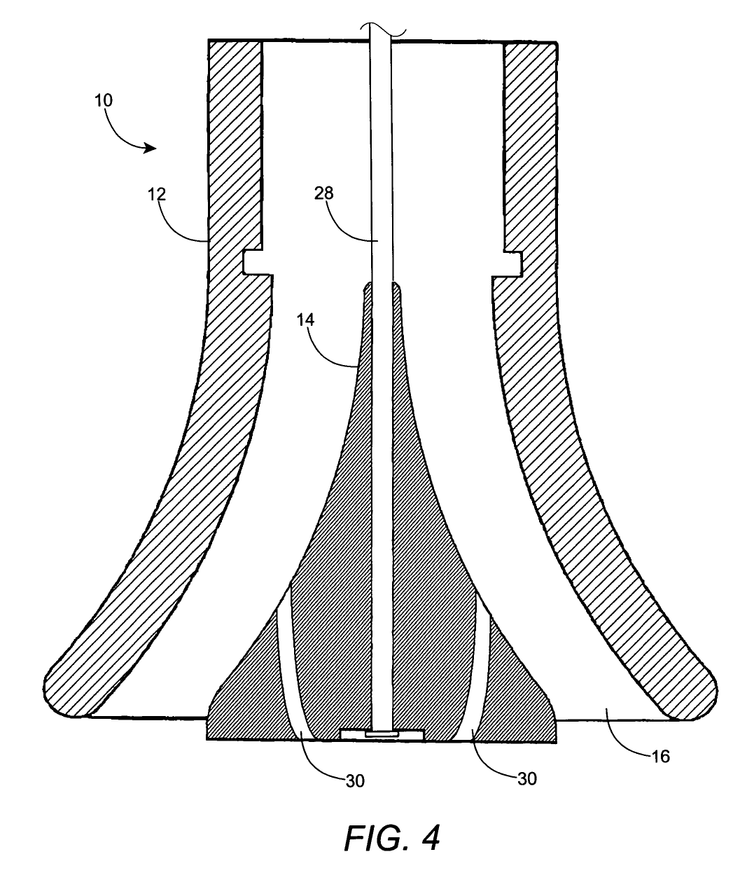

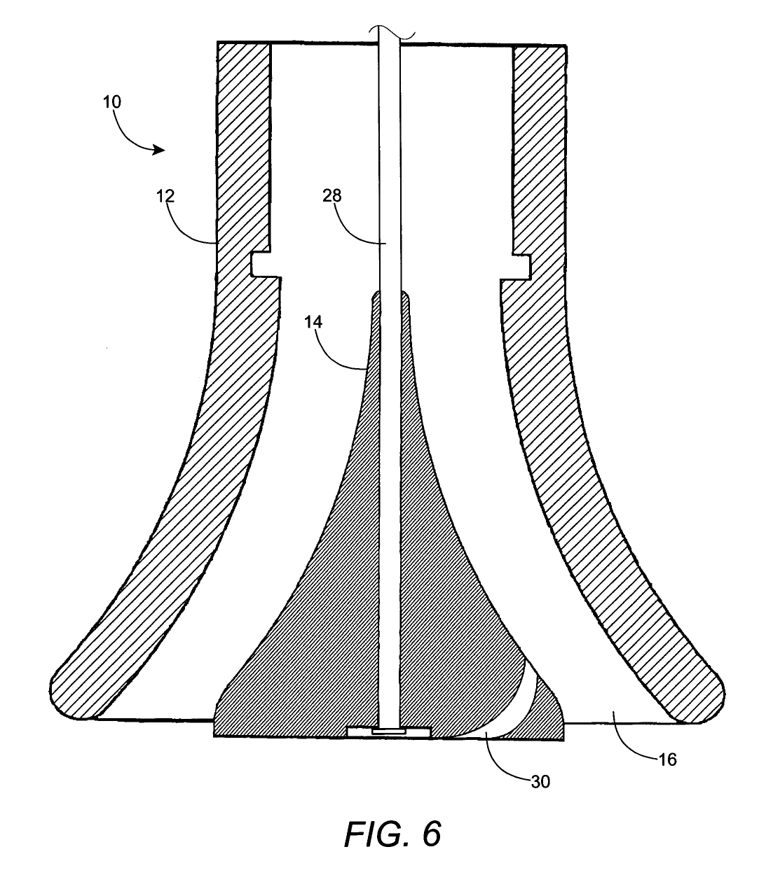

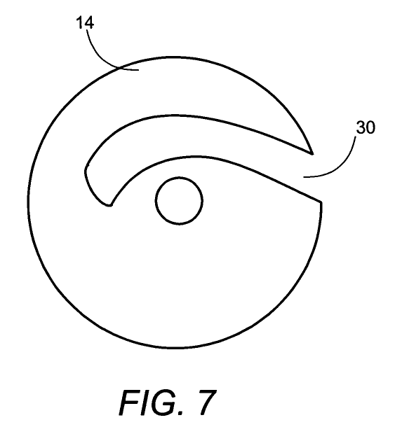

For example, in one optional embodiment shown in FIGS. 4-7, rotation of the deflector 14 can be facilitated by directing some of the compressed air foam through one or more channels 30 that pass from the tapered body 22 of the deflector 14 through the end of the deflector 14. With the channel or channels 30 angled with respect to the longitudinal axis 26 of the deflector 14, the compressed air foam drives the deflector 14 to rotate. In one optional embodiment, shown in FIGS. 6 and 7, where only one channel 30 is provided, an amount of mass may optionally be removed from the side of the deflector 14 opposite the channel to maintain the rotational balance of the deflector 14, however, this is not mandatory. Alternatively or additionally, the rotation of the deflector 14 may be facilitated by two or more grooves, ridges, or other similarly functioning straight or curved shapes on the surface of the deflector 14 angled down toward the point of departure of the foam from the deflector 14.

In another optional embodiment of the nozzle 10, the deflector 14 is fixed and does not rotate. In such an optional embodiment, such as that shown in FIGS. 1-3 and 8, the deflector may be continuous without channels or grooves.

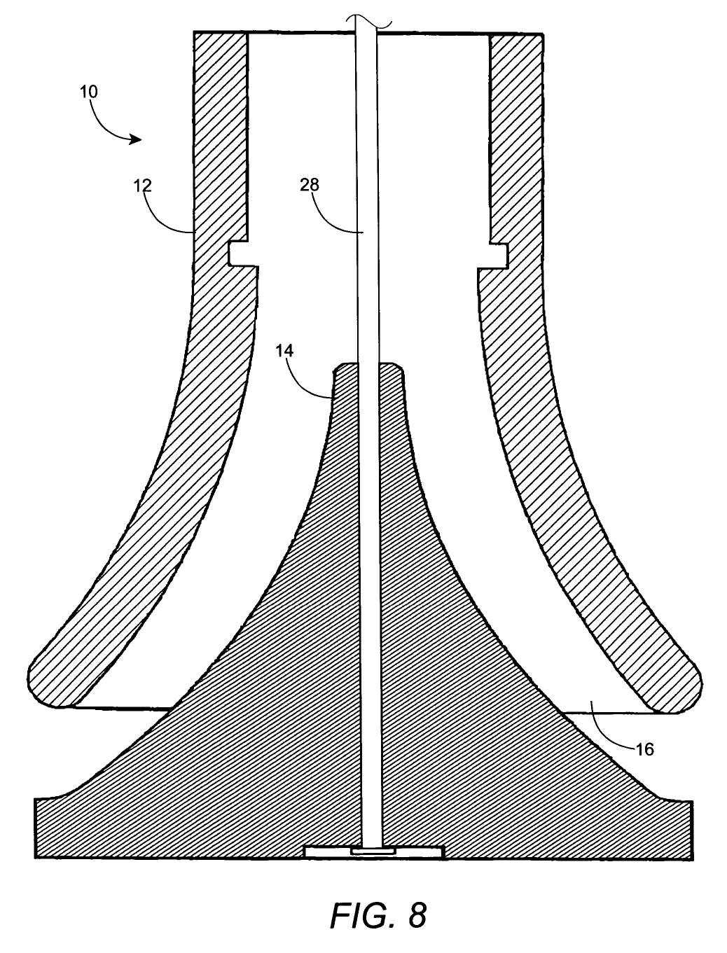

It is noted that the final angle of departure of the nozzle 10 can alter the area of coverage of the nozzle 10, as well as the resulting velocity of the foam. This could be adjusted by the positioning of the deflector 14 in the hollow barrel 12, as well as the shape of the deflector 14 and the outlet 20. For example, an 80° total arc in both the nozzle barrel 12 and the deflector 14 achieves approximately 60° of foam coverage (30° from each side of the longitudinal axis 26 of the foam nozzle 10). In a more extreme case, such as that shown in FIG. 8, the deflector 14 may be sized and shaped, and positioned with respect to the outlet 20, such that compressed air foam is broadcast substantially laterally from the nozzle 10. A wide range of arcs of coverage may be provided in order to meet the particular requirements of other special applications and even other types of foam.

Additionally, the passageway 16 may define less than a full circle such that foam is broadcast directionally. For example, in an embodiment in which the hollow barrel 12 forms a segment of a circle in cross-section, and the deflector 14 is adjacent the chord dividing the circle, the broadcast will be directed to the arc formed by the passageway 16. Thus, passageway 16 that forms an arc of 90° could be corner-mounted and broadcast compressed air foam in a 90° arc.

It is further contemplated that the nozzle 10 of the present invention may be mounted in any orientation relative to the direction of gravity and the surface to be coated with compressed air foam. More specifically, the nozzle 10 may be positioned with the outlet directed vertically upward, vertically downward, horizontally, or varying angles between vertically upward and vertically downward.

The area of coverage and velocity of the foam is in part determined by the gap between the deflector 14 and the hollow barrel 12. In an optional embodiment, the position of the deflector 14 with respect to the outlet 20 is adjustable. In a further optional embodiment, the attachment mechanism 28 connecting the deflector 14 and the hollow barrel 12 may be configured to allow this adjustment to be performed while the nozzle 10 is in use.

While not in use, an optional embodiment may include the deflector 14 being received, at least partially, into the hollow barrel 12. In such an embodiment, the nozzle 10 may further include a removable cap (not shown) over the deflector 14 and outlet 20. In an optional embodiment in which the nozzle 10 is mounted on a ceiling, wall, or the like, the cap may be colored or painted to match the surface upon which the nozzle 10 is mounted. In any event, the cap may optionally be engaged to the nozzle 10 in such a way that the cap is disengaged from the nozzle 10 by the force of the compressed air foam.

While certain embodiments of the present invention have been shown and described it is to be understood that the present invention is subject to many modifications and changes without departing from the spirit and scope of the claims presented herein.

1. A nozzle for the broadcasting of compressed air foam, comprising:
a hollow barrel having an inlet and an outlet, said hollow barrel expanding toward said outlet; and
a deflector suspended inside said hollow barrel proximate said outlet, said deflector having a tapered body expanding toward said outlet to a convexly curved surface, the space between said hollow barrel and said deflector defining a passageway for said compressed air foam.

2. The nozzle of claim 1 wherein said hollow barrel has an inside surface with a substantially frustoconical shape expanding toward said outlet.

3. The nozzle of claim 2 wherein said inside surface defining said frustoconical shape is flat.

4. The nozzle of claim 2 wherein said inside surface defining said frustoconical shape is curvilinear.

5. The nozzle of claim 4 wherein said curvilinear surface is defined by a hyperbolic curve.

6. The nozzle of claim 4 wherein said curvilinear surface is defined by a logarithmic curve.

7. The nozzle of claim 4 wherein said curvilinear surface is a defined by an elliptical arc.

8. The nozzle of claim 7 wherein said elliptical arc is a circular arc.

9. The nozzle of claim 2 wherein said tapered body is has a substantially frustoconical shape formed about a longitudinal axis to conform to the shape of said inside surface while defining a passageway for said compressed air foam.

10. The nozzle of claim 9 wherein said convexly curved surface is configured to direct at least a portion of said compressed air foam toward said longitudinal axis.

11. The nozzle of claim 1 wherein said deflector is rotatable about a longitudinal axis and terminates in an end, said deflector including at least one channel having an opening on said body communicating with an opening at said end, said channel angled with respect to said longitudinal axis such that compressed air foam passing through said channel causes said deflector to rotate.

12. The nozzle of claim 1 wherein said passageway defines an arc of less than a complete circle to broadcast said compressed air foam in an arc of less than a complete circle.

13. The nozzle of claim 1 wherein said deflector shape expands to a shape and size with respect to said outlet to define a passageway that broadcasts said compressed air foam substantially laterally with respect to the path of said compressed air foam within said hollow barrel.

14. The nozzle of claim 1 wherein said deflector is at least partially retractable into said hollow barrel.

15. The nozzle of claim 14 wherein said deflector is retained in a retracted position inside said barrel by a removable cap engaging said nozzle, said removable cap positioned with respect to said passageway such that said removable cap is disengaged by said compressed air foam.

16. The nozzle of claim 1 wherein the position of said deflector with respect to said outlet is adjustable.

17. A nozzle for the broadcasting of compressed air foam, comprising:
a hollow barrel having an inlet and an outlet, said hollow barrel including an inside surface has a substantially frustoconical shape with a curvilinear surface expanding toward said outlet; and
a deflector suspended inside said hollow barrel proximate said outlet, said deflector having a tapered body expanding toward said outlet to a convexly curved surface, the space between the inside surface of said hollow barrel and said deflector defining a passageway for said compressed air foam.

18. The nozzle of claim 17 wherein said tapered body has a substantially frustoconical shape with a curvilinear surface formed about a longitudinal axis to conform to the shape of said inside surface while defining a passageway for said compressed air foam.

19. The nozzle of claim 18 wherein said convexly curved surface is configured to direct at least a portion of said compressed air foam toward said longitudinal axis.

20. The nozzle of claim 17 wherein said deflector is rotatable about a longitudinal axis and terminates in an end, said deflector including at least one channels having an opening on said body communicating with an opening at said end, said channel angled with respect to said longitudinal axis such that compressed air foam passing through said channel causes said deflector to rotate.

21. A nozzle for the broadcasting of compressed air foam, comprising:
a hollow barrel having an inlet and an outlet, said hollow barrel including an inside surface having a substantially frustoconical shape with a curvilinear surface expanding toward said outlet; and
a deflector suspended inside said hollow barrel proximate said outlet, said deflector having a tapered body having a substantially frustoconical shape with a curvilinear surface formed about a longitudinal axis to conform to the shape of said inside surface, said tapered body expanding toward said outlet transitioning to a convexly curved surface configured to direct at least a portion of said compressed air foam toward said longitudinal axis, the space between the inside surface of said hollow barrel and said deflector defining a passageway for said compressed air foam with said foam directed toward said longitudinal axis preventing creation of a central void in said broadcast.

22. The nozzle of claim 21 wherein said deflector is rotatable about said longitudinal axis and terminates in an end, said deflector including at least one channels having an opening on said body communicating with an opening at said end, said channel angled with respect to said longitudinal axis such that compressed air foam passing through said channel causes said deflector to rotate.

23. A nozzle for the broadcasting of compressed air foam, comprising:
a hollow barrel having an inlet and an outlet, said hollow barrel expanding toward said outlet; and
a deflector suspended inside said hollow barrel proximate said outlet, said deflector rotatable about a longitudinal axis, said deflector having a tapered body expanding toward said outlet and terminating in an end, the space between said hollow barrel and said deflector defining a passageway for said compressed air foam, said deflector including at least one channel having an opening on said body communicating with an opening at said end, said channel angled with respect to said longitudinal axis such that compressed air foam passing through said channel causes said deflector to rotate.

24. The nozzle of claim 23 wherein said hollow barrel has an inside surface having a substantially frustoconical shape with a curvilinear surface expanding toward said outlet.

25. The nozzle of claim 23 wherein said tapered body has a substantially frustoconical shape having a curvilinear surface formed about a longitudinal axis to conform to the shape of said inside surface while defining a passageway for said compressed air foam.
